(19) United States
(12) Patent Application Publication
(10) Pub. No.: US 2007/0056831 A1
(43) Pub. Date: Mar. 15, 2007

(54) Lift and carry accumulation system for racks with palletized loads

(76) Inventor: Nigel Sullivan, Markham (CA)

Correspondence Address: FROMMER LAWRENCE & HAUG, 745 FIFTH AVENUE- 10TH FL., NEW YORK, NY, 10151, US

(21) Appl. No.: 11/519,674

(22) Filed: Sep. 12, 2006

(30) Foreign Application Priority Data
Sep. 13, 2005 (CA) 2,519,730

(51) Int. Cl. B65G 25/00; B65G 65/00

(52) U.S. Cl. 198/774.1; 414/266

(57) ABSTRACT

A lift and carry accumulation system for racks with palletized loads is disclosed. The lift and carry accumulation system of the present invention provides a reciprocating load transfer cart equipped with gear motor and positioning sensors for advancing and retracting racks with palletized loads with the aids of inflatable lift tube members mounted thereon for raising and isolating the loads from the system base frame. The transfer cart is driven along a pair of elongated, spaced apart, parallel stationary rail mounted to the base frame thereon.

This application claims priority benefits from Canadian Patent Application No. 2,519,730 filed Sep. 13, 2005

### FIELD OF THE INVENTION

This invention relates generally to a lift and carry accumulation system for palletized loads and, more particularly, to a lift and carry accumulation system employing reciprocating load transfer carts equipped with gear motor and self-guided positioning sensors for advancing and retracting loads with the aids of lift tube members mounted thereon for raising and isolating the loads from the system base frame.

### BACKGROUND OF THE INVENTION

Lift and carry conveyors for transporting various types of palletized loads along a conveyor belt are known. Conventional lift and carry conveyors typically comprise a pair of spaced apart and parallel stationary rails as well as at least one movable rail which extends generally parallel to the stationary rails. The movable rail is movable both between a forward and a retracted position.

However, the conventional lift and carry conveyors are not designed for handling large palletized loads common in some heavy industries, such as the automotive industry. Furthermore, many manufacturing concerns, particularly in the automotive industry, now operate on the “just-in-time” principle, which means that component parts from other parts of the plant or from outside suppliers are delivered to an assembly area with minimal storage flow just before they are to be used. No matter how a business operates, if it accumulates, stores or uses inventory it will be faced with the problem of moving and storing that inventory and of ensuring that the inventory is retrieved and used in the correct sequence. Computerized inventory control is now the norm, especially in “just-in-time” manufacturing situations and it is now essential that any system in which inventory is to be placed be adaptable to computer control. It is also essential that inventory storage and retrieval systems be economical to purchase and operate. Thus, conventional lift and carry conveyors are not suitable for handling such loads.

Attempts have been made to overcome the aforementioned problems, particularly targeting the automotive industry. One such attempt is disclosed in U.S. Pat. No. 4,887,706, owned by the common assignee of the present invention.

The accumulation system described in U.S. Pat. No. 4,887,706 provides an accumulation system which utilizes a basic transport system that can move and/or accumulate palletized loads in an organized travel route for either FIFO (First In First Out) or FILO (First In Last Out) operation, can be computer controlled, and can be expanded horizontally and/or vertically to create a high density accumulation, storage and retrieval system. In its broadest form U.S. Pat. No. 4,887,706 provides a pallet moving and accumulation system for palletized loads comprising: (a) elongated deck support frame; (b) elongated deck cart coacting with the support frame to support and guide the deck cart for reciprocal movement relative thereto; (c) drive cylinder connected to the deck cart for reciprocally moving the deck cart; and (d) pallet lifting member on each side of the deck support for lifting pallets in the system away from the deck cart to permit the deck cart to move the palletized loads.

In order to operate the U.S. Pat. No. 4,887,706 system, the pallet moving and accumulation system provides a framework or base in or on which the deck support frames will be mounted. The support frames are typically roller or ball-type conveyors but preferably SAILRAIL® (trademark of SailRail Automated Systems Inc.) aluminum rails-air film support components.

In the invention disclosed in U.S. Pat. No. 4,887,706, air-pressurized rails are employed to move the deck cart and its palletized loads between two positions. The system described in U.S. Pat. No. 4,887,706 functions quite satisfactorily and has been well received by the material handling and logistic users, particularly the automotive industry. However, one of the limiting factor in operating the system described in U.S. Pat. No. 4,887,706 is that the position of the lifting and lowering mechanism are affixed on the deck support frame. The present inventors have since developed an alternative system compared to that earlier system, this latter alternative system being the object of the present application.

### SUMMARY OF THE INVENTION

In view of the foregoing disadvantages inherent in the known types of lift and carry accumulation system now present in the prior art, the present invention provides a new lift and carry accumulation system construction. The general purpose of the present invention, which will be described subsequently in greater detail, is to provide a lift and carry accumulation system for palletized loads and, more particularly, to a lift and carry accumulation system employing reciprocating load transfer carts equipped with gear motor and self-guided by positioning sensors for advancing and retracting loads with the aids of lift tube members mounted thereon for raising and isolating the loads from the system base frame.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a lift and carry accumulation system for palletized loads which has many of the advantages of the lift and carry accumulation system mentioned heretofore and many novel features that result in a new lift and carry accumulation system which is not anticipated, rendered obvious, suggested, or even implied by any of the prior art a lift and carry accumulation system, either alone or in any combination thereof.

It is another object of the present invention to provide a new lift and carry accumulation system for palletized loads which may be easily and efficiently manufactured and marketed.

It is a further object of the present invention to provide a new lift and carry accumulation system for palletized loads which is of a durable and reliable construction.

Still yet another object of the present invention is to provide a new lift and carry accumulation system for palletized loads which provides in the apparatuses and methods of the prior art some of the advantages thereof, while simultaneously overcoming some of the disadvantages normally associated therewith.

Still another object of the present invention is to provide a transfer cart with lift tube members mounted thereon for raising and isolating the loads from the system base frame.

It is yet another object of the present invention to provide a lift and carry accumulation system equipped with a gear motor housed in the load transfer cart thereunder.

A further object of the present invention is to provide a plurality of positioning sensors for self-guiding the advancing and retracting of the transfer carts.

According to one aspect of the present invention, it provides a lift and carry accumulation system for racks with palletized loads comprising (a) a base frame having a pair of elongated, spaced apart, parallel rack support shafts at the outboard edges and a pair of elongated, spaced apart, parallel rails towards the centre; (b) a transfer cart driven on the rails for reciprocal movement relative thereto; (c) drive means for reciprocally moving the transfer cart between a first and a second positions, the drive means including a gear motor housed thereunder the transfer cart; and (d) rack lift tube means provided on the outboard edges of the transfer cart for lifting the rack in the system away from the transfer cart to permit the transfer cart to move with the rack from the first position to the second position and for lowering the rack onto the rack support shafts thereon to enable the transfer cart moves from the second position back to the first position; the lift tube means including an elongated tube support member extending along the outboard edges of the transfer cart, inflatable tube means on each of the support members, an elongated lifting member atop each the tube means, and pressurizing means for selectively inflating the tube means to lift the lifting members into lifting engagement with any rack resting on the transfer cart or for selectively deflating the tube means for lowering any rack previously lifted and carried by the transfer cart to rest on the rack support shaft.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view showing the basic configuration of the present invention.

FIG. 2 is an end view of the FIG. 1 configuration with the pallet load resting on the base frame and clear of the transfer cart and with the lift tube members at the resting position.

FIG. 3 is an end view of the FIG. 1 configuration with the pallet raised clear of the base frame and resting on the transfer cart and with the lift tube members at the raised position.

FIG. 4 is a perspective view showing the gear motor housed in the transfer cart thereunder.

FIG. 5 is a plan view of the basic system illustrating typical positions for logic control switches or sensors and flags.

FIG. 6 is an elevational view showing typical positions for additional logic control switches or sensors and flags.

### DETAILED DESCRIPTION OF THE PREFERRED EMBODIMENT

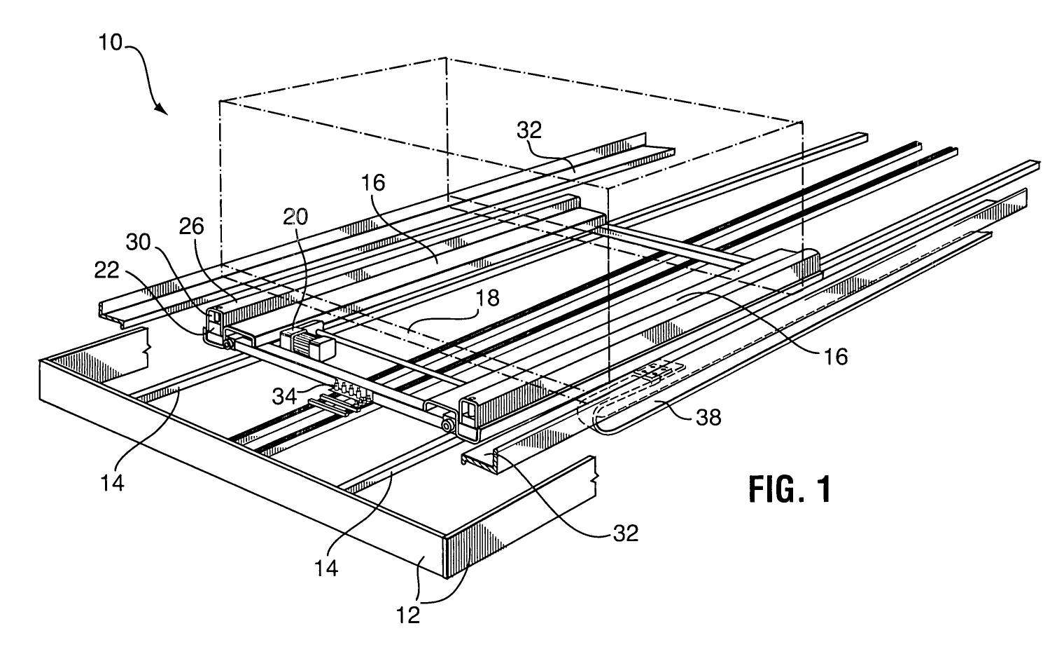

With reference now to the drawings, and in particular to FIGS. 1 through 3 thereof, a lift and carry accumulation system for palletized loads embodying the principles and concepts of the present invention and generally designated by the reference numeral 10 will be described.

FIG. 1 illustrates, in perspective, the basic lift and carry accumulation system 10 of this invention. As shown, the system is assembled on a rigid outer base frame 12, which could be a stand-alone structure or part of the framework of a storage racking system (not shown). The base frame 12 is intended to represent an appropriate mounting support of a length and width appropriate to the loads on racks to be carried by the system.

A pair of elongated, spaced apart, parallel stationary shafts 32 are provided atop the outboard edge of the base frame 12 for the entire rack 18 or part thereof to be disposed thereon.

Mounted on and welded to the base frame 12 and towards the center is a pair of transversely spaced apart and parallel rails 14. The rails 14 are designed to accommodate both flanged and plain wheels (not shown) rotatably mounted on the transfer cart 16. The rails are made from conventional materials and, preferably, made from 1″× 2/4″ cold rolled steel.

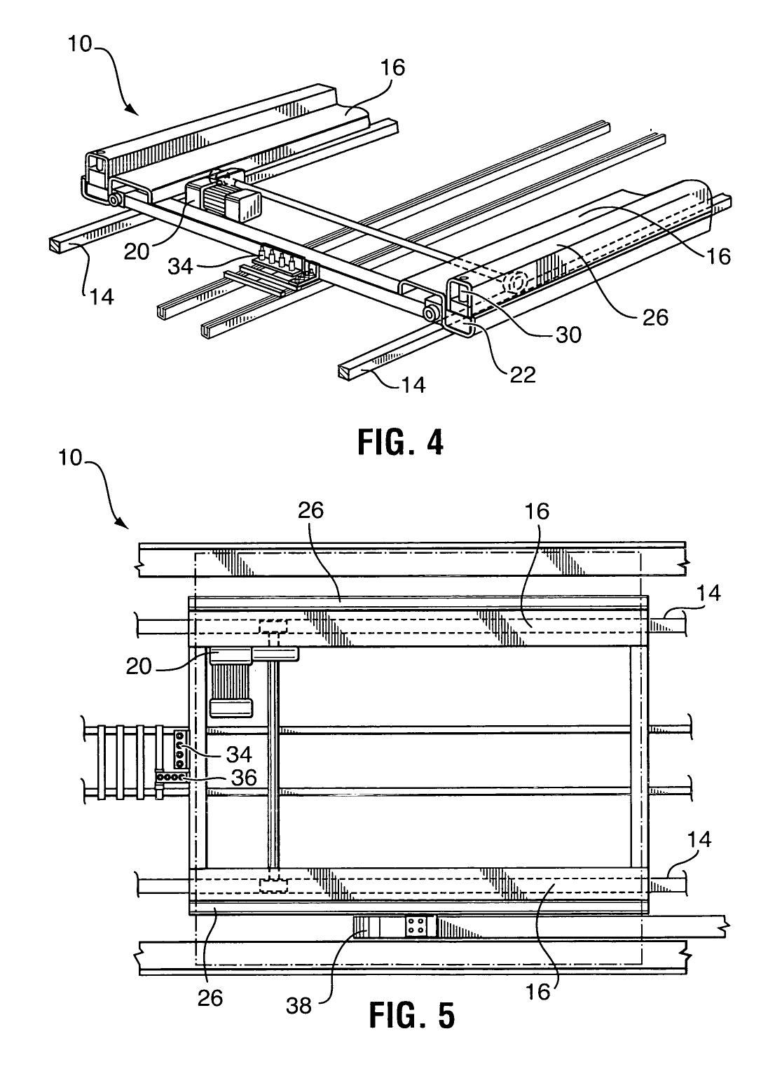

Transfer cart 16 rides on rails 14. It is powered by an electrical gear motor 20 operatively housed in the transfer cart 16 thereunder (see FIG. 4). Transfer cart 16 works with any conventional gear motor. A preferred gear motor has the following specification:

| | |
|---|---|
| Demag Gear Motor | Output = 77.5 RPM, Ratio = 22.20 |
| Part Number: | AME20DD-ZBA71 B4-B007 |
| Ratings | 0.6 HP 480VAC/1.5amps |

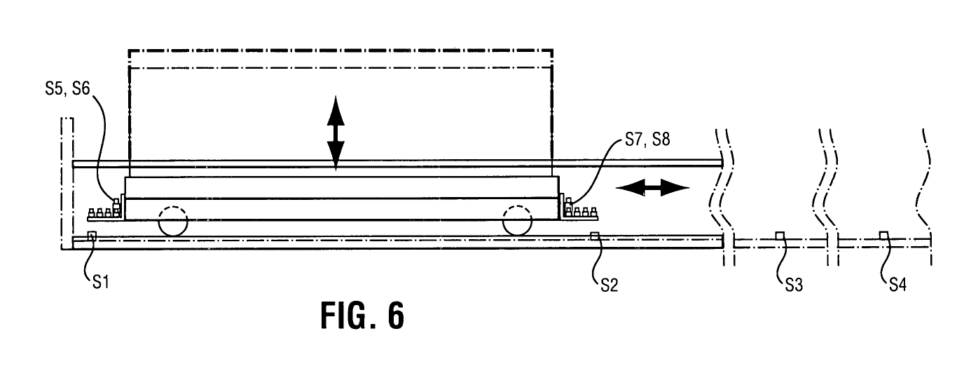

In order to detect the precise location and movement of transfer cart 16, either with or without the racks with palletized loads thereon, the present invention provides for a plurality of sensors 34 mounted to the resting transfer cart 16 thereon (see FIGS. 5 and 6). Corresponding sensor-flags 36 are strategically located at various parts of the structures on system 10. Sensors 34 serve two related functions, namely (i) to identify the position where transfer cart 16 is approaching and to initiate deceleration of the transfer cart 16 prior to halting the gear motor 20 from continue operation. The identification of the position is done via a binary method in cooperation with sensor-flags 36, therefore the number of sensors used is dependent upon the number of positions in the lift and carry accumulation system 10; and (ii) to initiate the final deceleration and complete halting of the transfer cart 16 from advancing or retracting in both directions.

The sensors 34 send signals back to the programmable logic controller (PLC) located elsewhere in system 10 (not shown). The PLC takes this information and sends signals to the variable frequency drive (VFD) which in turn controls the gear motor 20 and drives the transfer cart 16.

As shown in FIGS. 1 to 3, the base frame 12 supports thereon a rack 18 which contains palletized loads for infeeding by transfer cart 16. Transfer cart 16 is narrower than the rack 18 to be carried thereby.

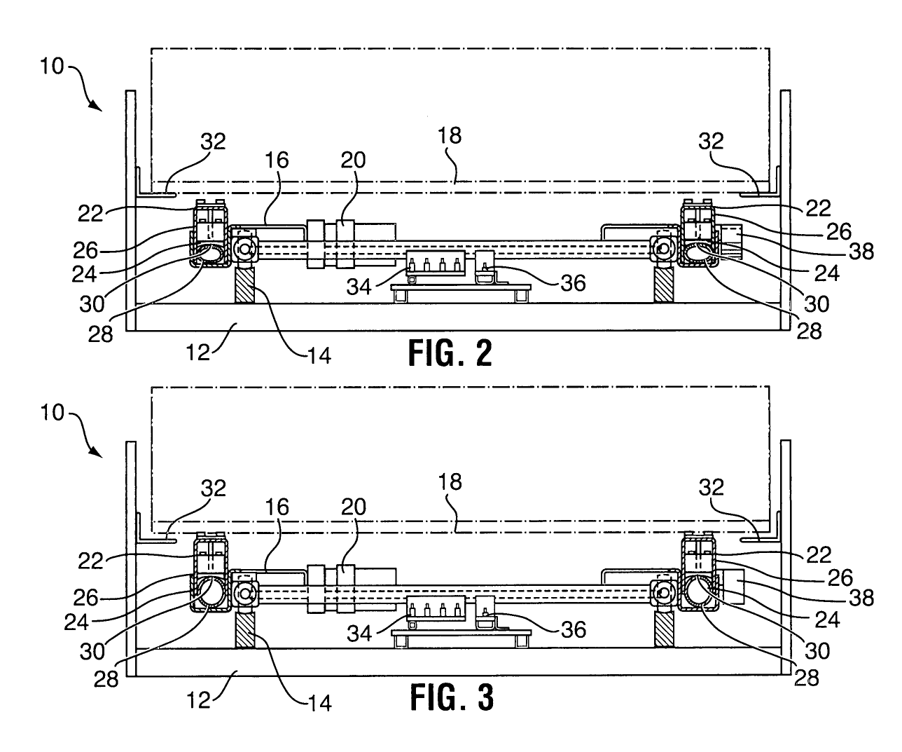

A pair of lift tube members 22 are provided along each outboard edge of the transfer cart 16, those members being best shown in FIGS. 2 and 3. Therein it is seen that members 22 include a rectangular support member 24, a vertically guided inverted U-shaped or H-shaped lifting member 26 and an inflatable tube member 28 positioned between the support member 24 and the lifting member 26. Typically, the tube member 28 can be a 2½Δ fire hose. Tube member 28 can be inflated using conventional technologies, such as by pneumatic inflation to pressurize and inflate the tube members. Furthermore, the upper surface of the support member 24 can be provided with a longitudinally extending recess 30 therein to help locate the tube member when it has expanded. Unlike the lifting mechanism disclosed in the U.S. Pat. No. 4,887,706 system, guide angles are not required on the lift tube members 22. The lift and carry transfer cart 16 of the present invention does not pick up on the out side edge of the base frame 12. With the present system, the guide angles are fixed and welded to the outside support structure.

Since the transfer cart 16 is driven by gear motor 20 and transfer cart 16 has a pair of air pressurized lift tube members 22 mounted thereon, together with a plurality of sensors 34 for self-guided positioning, air supply and electrical supply are required in order to power and control the operation of transfer cart 16. These supplies are provided through a special flexible track that encloses and guides the hoses and cables, generally called a “Cat Track” or cable management system 38 (see FIG. 1).

The operation of the basic lift and carry accumulation system 10 will now be described for a simple task of moving loads along the length of the system.

The operation starts with the rack 18 having pallets being disposed thereon at a resting position on the pair of elongated shafts 32 on the base frame 12. A sensor 34 detects the presence of the rack 18 and causes the gear motor 20 to start and to drive the transfer cart 16 along rails 14 to a first position directly underneath rack 18. Once the transfer cart 16 comes to a full stop, lifting members 26 are actuated to the raised position, that is with all of the tube members 28 inflated with pressurized air, causing rack 18 to be lifted up and isolating rack 18 to become clear from the shafts 32. Another sensor 34 detects the lifting action and causes the gear motor 20 to start and to drive the transfer cart 16 forward, thus carrying and advancing the rack 18 to a second position, e.g., the next workstation. After transfer cart 16 comes to a full stop at the second position, a sensor 34 causes the lifting members 26 to be lowered to allow the indexed rack 18 to rest on the pair of elongated shafts 32 at this second position of the base frame 12, thereby permitting the transfer cart 16 to retract freely therebelow back to the first position of the base frame 12 for the next indexing drive.

As indicated previously, suitable control circuitry can be provided to have the system operate in any desired fashion. For example, the system could automatically advance all racks upon detection of a rack being removed from the second position of the base frame 12, thereby ensuring that there is always a rack (e.g., a supply of parts) at the second position (e.g., a worker's assembly station). The control could also advance the first rack all of the way to the end of the base frame 12 in continuous advancing motor drive movements of the transfer cart 16.

Control of the system can be through pneumatic or electronic logic circuitry with the various functions being initiated or terminated in response to inputs from various actuators such as sensors 34 and sensor-flags 36 positioned within the system at specific strategic points. With reference to FIGS. 4 and 5 it can be seen that full control can be achieved with just eight sensors, S1 to S8. For instance, referring to FIG. 6, if base frame 12 provides for four transfer positions, sensor S1 will sense when a rack is placed at the first position of the base frame 12 and sensor S2 will detect the presence of a rack at the second position. Sensor S3 will detect the presence of a rack at the first position of the intermediate section and sensor S4 will detect the presence of a rack at the last position of the intermediate section of the base frame 12. Sensors S5 and S6 detect when the transfer cart 16 is retracted or advanced respectively; and sensors S7 and S8 detect when the lifting members 26 of the lift tube members 22 are in the raised or lowered condition. A rack actuating any of the switches S1 to S4 will prompt the logic circuit to either start the gear motor 20 to move the rack in the desired direction so as to achieve the desired movement of one, several or all racks residing in the system while maintaining a count of the number of racks moved into and out of the system. The circuitry used will depend on the flow of racks required for the individual application and is well within the capabilities of a competent engineer and need not be described in detail herein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

What is claimed is:

1. A lift and carry accumulation system for racks with palletized loads comprising:
(a) a base frame having a pair of elongated, spaced apart, parallel rack support shafts at the outboard edges and a pair of elongated, spaced apart, parallel rails towards the centre;
(b) a transfer cart driven on said rails for reciprocal movement relative thereto;
(c) drive means for reciprocally moving said transfer cart between a first and a second positions, said drive means including a gear motor housed thereunder said transfer cart; and
(d) rack lift tube means provided on the outboard edges of said transfer cart for lifting said rack in said system away from said transfer cart to permit said transfer cart to move with said rack from said first position to said second position and for lowering said rack onto said rack support shafts thereon to enable said transfer cart moves from said second position to said first position; said lift tube means including an elongated tube support member extending along said outboard edges of said transfer cart, inflatable tube means on each of said support members, an elongated lifting member atop each said tube means, and pressurizing means for selectively inflating said tube means to lift said lifting members into lifting engagement with any rack resting on said transfer cart or for selectively deflating said tube means for lowering any rack previously lifted and carried by said transfer cart to rest on said rack support shafts.

2. The lift and carry accumulation system of claim 1 including a plurality of logic control actuator means positioned adjacent said drive means and said base frame to control the interrelated movements of said drive means and said base frame whereby racks with palletized loads introduced to said system at said first position can advance through said system to said second position.
